(19) United States
(12) Patent Application Publication
(10) Pub. No.: US 2010/0162392 A1
(43) Pub. Date: Jun. 24, 2010

(54) APPARATUS AND METHOD FOR MONITORING SECURITY STATUS OF WIRELESS NETWORK

(75) Inventors: Chi Yoon JEONG, Daejeon (KR); Beom Hwan CHANG, Daejeon (KR); Seon Gyoung SOHN, Daejeon (KR); Jong Ho RYU, Cheonan-si (KR); Geon Lyang KIM, Daejeon (KR); Jong Hyun KIM, Daejeon (KR); Jung-Chan NA, Daejeon (KR); Hyun Sook CHO, Daejeon (KR); Chae Kyu KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/482,716

(22) Filed: Jun. 11, 2009

(30) Foreign Application Priority Data
Dec. 22, 2008 (KR) 10-2008-0131716

(51) Int. Cl. H04L 9/00; G06F 11/30

(52) U.S. Cl. 726/22

(57) ABSTRACT

An apparatus for monitoring the security status of a wireless network is provided. The apparatus includes a radio frequency (RF) signal collection unit which collects at least one piece of RF signal information; a security event information collection unit which collects security event information including at least one of traffic information and alert information; a security event information mapping unit which maps the RF signal information and the security event information based on the correlation between the RF signal information and the security event information; and a security event information display unit which displays the result of the mapping performed by the security event information mapping unit. Therefore, it is possible to allow a network administrator to intuitively recognize the security status of a wireless network by collecting RF signal information and security event information from the wireless network, mapping the RF signal information and the security event information based on the correlation therebetween and displaying the result of the mapping.

### CROSS-REFERENCE TO RELATED APPLICATION

This application claims priority from Korean Patent Application No. 10-2008-0131716, filed on Dec. 22, 2008 in the Korean Intellectual Property Office, the disclosure of which is incorporated herein by reference in its entirety.

### BACKGROUND OF THE INVENTION

1. Field of the Invention

The present invention relates to an apparatus and method for monitoring the security status of a wireless network, and more particularly, to an apparatus and method for monitoring the security status of a wireless network, in which RF signal information and security event information are mapped based on the correlation therebetween and the result of the mapping is displayed.

The present invention is based on research (Project Management No.: 2007-S-022-02, Project Title: Development of System for Monitoring and Tracking Intelligent Cyber Attacks in All IP Environment) conducted as part of Information Technology (IT) Growth Power Technology Development Project launched by Ministry of Knowledge Economy and Institute for Information Technology Advancement (IITA).

2. Description of the Related Art

There are two different methods of monitoring the security status of a wireless network: a wireless network-based method and a wired network-based method. The wireless network-based method may be classified into a first method of displaying information regarding attacks detected by security equipment for a wireless network or a second method of collecting traffic information from wireless network equipment and displaying statistical data corresponding to the collected traffic information.

In the first method, a sensor for sensing radio frequency signals from a wireless network or an access point (AP) having an attack detection function may analyze wireless traffic, may determine whether a cyber attack has been launched and may transmit the results of the determination to an administration server. Then, the administration server may display alert data on a screen as a table or a graph. In the first method, however, if the sensor or the AP fails to detect a cyber attack, a network administrator may not be able to recognize a cyber attack.

In the second method, an AP or an event collecting agent for collecting RF signals may collect wireless traffic and may transmit the collected traffic to an administration server. Then, the administration server may display statistical data regarding the collected traffic on a screen. However, since, in the second method, only the statistical data is transmitted to a network administrator, it may be difficult for the network administrator to acquire detailed information regarding an abnormal phenomenon, if any, detected from a wireless network.

In the wired network-based method, statistical data corresponding to traffic information or alert information provided by a wired network to which a number of APs are connected may be displayed on a screen. However, the wired network-based method may not be able to properly reflect the properties of a wireless network. In addition, it is difficult to provide a network administrator with detailed information regarding the security status of a wireless network.

### SUMMARY OF THE INVENTION

The present invention provides an apparatus and method for monitoring the security status of a wireless network, which can allow a network administrator to intuitively recognize the security status of a wireless network by collecting radio frequency (RF) signal information and security event information from the wireless network, mapping the RF signal information and the security event information based on the correlation therebetween and displaying the result of the mapping.

According to an aspect of the present invention, there is provided an apparatus for monitoring the security status of a wireless network, the apparatus including an RF signal collection unit which collects at least one piece of RF signal information; a security event information collection unit which collects security event information including at least one of traffic information and alert information; a security event information mapping unit which maps the RF signal information and the security event information based on the correlation between the RF signal information and the security event information; and a security event information display unit which displays the result of the mapping performed by the security event information mapping unit.

According to another aspect of the present invention, there is provided a method of monitoring the security status of a wireless network, the method including collecting at least one piece of RF signal information; collecting security event information including at least one of traffic information and alert information; mapping the RF signal information and the security event information based on the correlation between the RF signal information and the security event information; and displaying the result of the mapping.

According to the present invention, it is possible to allow a network administrator to intuitively recognize the security status of a wireless network by collecting RF signal information and security event information from the wireless network, mapping the RF signal information and the security event information based on the correlation therebetween and displaying the result of the mapping.

### BRIEF DESCRIPTION OF THE DRAWINGS

The above and other features and advantages of the present invention will become more apparent by describing in detail preferred embodiments thereof with reference to the attached drawings in which:

FIG. 1 illustrates a block diagram of a system for monitoring the security status of a wireless network according to an exemplary embodiment of the present invention;

FIG. 2 illustrates a block diagram of an apparatus for monitoring the security status of a wireless network according to an exemplary embodiment of the present invention;

FIG. 3 illustrates a diagram of a screen image in which traffic information regarding a wireless network device and radio frequency (RF) information are both displayed;

FIG. 4 illustrates a diagram of a security status screen for displaying the security status of a wireless network according to an exemplary embodiment of the present invention; and

FIG. 5 illustrates a diagram of a security status screen for displaying the security status of a wireless network according to another exemplary embodiment of the present invention.

### DETAILED DESCRIPTION OF THE INVENTION

The present invention will hereinafter be described in detail with reference to the accompanying drawings in which exemplary embodiments of the invention are shown.

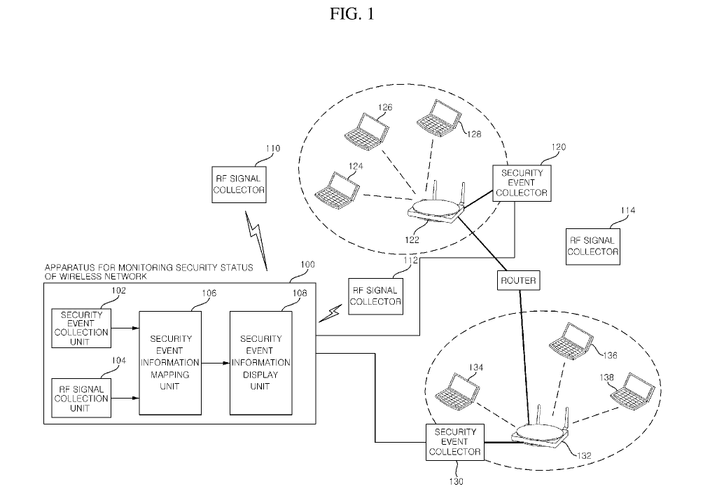

FIG. 1 illustrates a block diagram of a system for monitoring the security status of a wireless network according to an exemplary embodiment of the present invention. Referring to FIG. 1, the system may include a plurality of wireless terminals 124, 126, 128, 134, 136 and 138, a wireless network device 122 to which the wireless terminals 124, 126 and 128 are wirelessly connected, a wireless network device 132 to which the wireless terminals 134, 136 and 138 are wirelessly connected, security event collectors 120 and 130, radio frequency (RF) signal collectors 110, 112 and 124 and an apparatus 100 for monitoring the security status of a wireless network. The apparatus 100 may include a security event collection unit 102, an RF signal collection unit 104, a security event information mapping unit 106 and a security event information display unit 108. The wireless network devices 122 and 132 may be access points (APs).

The apparatus 100 may communicate with the security event collectors 120 and 130 and the RF signal collectors 110, 112 and 114 in a wired or wireless manner using such protocol as Transmission Control Protocol (TCP) or User Datagram Protocol (UDP). The apparatus 100 may receive data from a database.

The security event collection unit 102 may collect traffic data such as NetFlow or sFlow from the security event collectors 120 and 130, which collect traffic generated by the APs 122 and 132. The security event collection unit 102 may also collect alert data generated by wireless security equipment (such as a wireless intrusion detection system). The data collected by the security event collection unit 102 may include source and destination internet protocol (IP) information of traffic, source port number, destination protocol number and protocol information.

The RF signal collection unit 104 may receive RF signal information, which is generated as a result of RF signal monitoring performed by the RF signal collectors 110, 112 and 114. The RF signal information may include a service set identifier (SSID) of an access point (AP), the media access control (MAC) address of the AP, channel information, the amount of packets generated, the number of packets used for each wireless channel, cyclic redundancy check (CRC) error information, integrity check value (ICV) error information, the IP and MAC addresses of a host to which the AP is connected.

The security event information mapping unit 106 may classify the RF signal information provided by the RF signal collection unit 104 into a first group corresponding to the AP 122 and a second group corresponding to the AP 132, and may integrate RF signal information included in each of the first and second groups. In addition, the security event information mapping unit 106 may analyze the correlation between security event information provided by the security event collection unit 102 and the RF signal information provided by the RF signal collection unit 104, may map the security event information and the RF signal information based on the results of analysis, and may provide the results of mapping to the security event information display unit 108.

More specifically, the security event information mapping unit 106 may analyze the correlation between the security event information provided by the security event collection unit 102 and the RF signal information provided by the RF signal collection unit 104 with reference to, for example, AP information included in the RF signal information and AP information corresponding to whichever of the security event collectors 120 and 130 is the source of the security event information.

The security event information display unit 108 may display the results of mapping performed by the security event information mapping unit 106, may analyze a security event, may classify the security event into a certain type of abnormal phenomenon according to the result of analysis and may display the result of classification. In addition, the security event information display unit 108 may represent a wireless network as a 3-dimensional space.

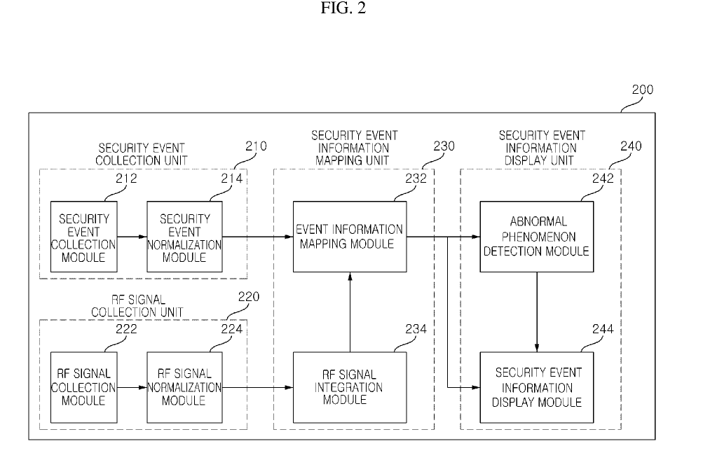

FIG. 2 illustrates a block diagram of an apparatus 200 for monitoring the security status of a wireless network according to an exemplary embodiment of the present invention. Referring to FIG. 2, the apparatus 200 may include a security event collection unit 210, an RF signal collection unit 220, a security event information mapping unit 230 and a security event information display unit 240. The security event collection unit 210 may include a security event collection module 212 and a security event normalization module 214. The RF signal collection unit 220 may include an RF signal collection module 222 and an RF signal normalization module 224. The security event information mapping unit 230 may include an event information mapping module 232 and an RF signal integration module 234. The security event information display unit 240 may include an abnormal phenomenon detection module 242 and a security event information display module 244.

The security event collection module 212 may receive various security event information from a database (not shown) or through TCP- or UDP-based network communication and may provide the received security event information to the security event normalization module 214. The security event normalization module 214 may normalize the security event information provided by the security event collection module 212 and may provide the normalized security event information to the event information mapping module 232.

The RF signal collection module 222 may receive RF signal information, which is generated as a result of RF signal monitoring, from a database (not shown) or through TCP- or UDP-based network communication and may provide the received RF signal information to the RF signal normalization module 224. The RF signal normalization module 224 may extract necessary RF signal information from the RF signal information provided by the RF signal collection module 222, may normalize the extracted RF signal information and may provide the normalized RF signal information to the RF signal integration module 234.

The RF signal integration module 234 may classify the normalized RF signal information provided by the RF signal normalization module 224 into a plurality of groups corresponding to different APs, and may integrate RF signal information included in each of the groups. RF signal information may be generated as a result of RF signal monitoring, and RF signal information generated by a single network equipment may be collected by more than one RF signal collector. Thus, it is necessary to classify all RF signal information collected by the RF signal collection module 222 into a plurality of groups corresponding to different APs and integrate RF signal information included in each of the groups. For example, if RF signal information generated by an AP x has n attributes and is collected by k RF signal collectors, an integrated attribute Xn of the AP x may be determined using Equation (1):

Xn=F(X1n, X2n, . . . , Xkn) (1)

where F indicates a function for integrating RF signal information.

The function F may be a function for extracting a unique value from a plurality of input values, averaging the input values or calculating a weighted average of the input values.

The RF signal integration module 234 may transmit the integrated RF signal information to the event information mapping module 232.

The event information mapping module 232 may analyze the correlation between data provided by the RF signal integration module 234 and data provided by the security event normalization module 214 and may map the data provided by the RF signal integration module 234 and the data provided by the security event normalization module 214 according to the results of the analysis. Since the data provided by the security event normalization module 214 includes an IP address, it is possible to determine the flow of traffic based on the data provided by the security event normalization module 214. In addition, it is possible to obtain detailed information regarding the current state of an AP from the data provided by the RF signal integration module 234. Therefore, it is possible for a network administrator to acquire not only information regarding the flow of traffic but also information regarding the state of an AP by mapping traffic information generated for each AP and detailed AP information obtained as a result of RF signal monitoring and integrating the results of mapping into event information. Event information generated by the event information mapping module 232 may be transmitted to the abnormal phenomenon detection module 242 and the security event information display module 244.

The abnormal phenomenon detection module 242 may determine whether an abnormal phenomenon has occurred in each of a plurality of APs by analyzing event information provided by the event information mapping module 232 for a corresponding AP. The abnormal phenomenon detection module 242 may notify the security event information display module 242 of abnormal wireless network device information indicating whichever of the APs is an abnormal AP where an abnormal phenomenon is detected.

The security event information display module 244 may represent the position of an AP and the position of a wireless terminal in a three-dimensional (3D) space and may display event information provided by the event information mapping module 232. More specifically, the security event information display module 244 may display the position of an AP using a geographical information system (GIS). In addition, the security event information display module 244 may display the abnormal wireless network device information provided by the abnormal phenomenon detection module 242 so as to be easily recognizable.

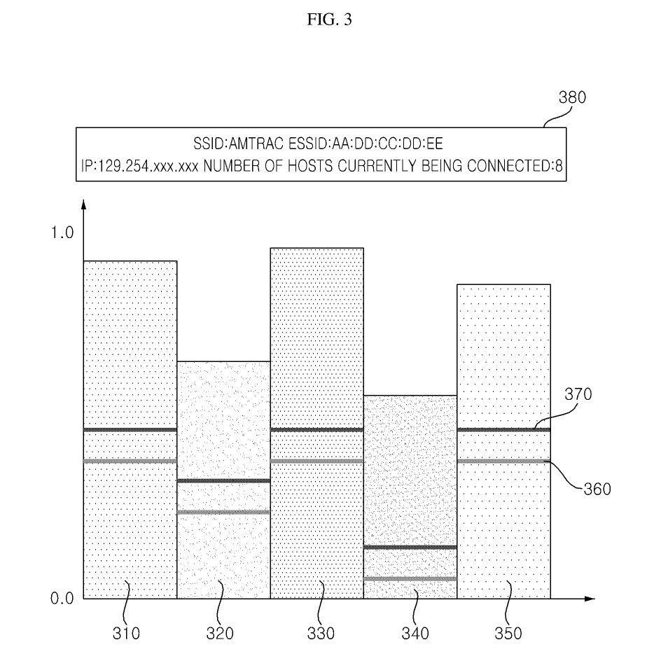

FIG. 3 illustrates a diagram of a screen image in which traffic information regarding traffic generated by an AP and RF signal information are both displayed. Referring to FIG. 3, a source IP dispersion 310, a source port number dispersion 320, a destination port number dispersion 330, a destination IP dispersion 340 and a traffic quantity dispersion 350 of traffic generated over a time period T by an AP may be calculated.

More specifically, the source IP dispersion 310 may be the ratio of the number of traffics having an original source IP address to the total number of traffics generated over the time period T. For example, if the total number of traffics generated over the time period T is 100 and the number of traffics having the original source IP address is 50, the source IP dispersion 310 may become 0.5.

The source port number dispersion 320, the destination port number dispersion 330, the destination IP dispersion 340 and the traffic quantity dispersion 350 may be calculated in the same manner as the source IP dispersion 310. The source IP dispersion 310, the source port number dispersion 320, the destination port number dispersion 330, the destination IP dispersion 340 and the traffic quantity dispersion 350 may all be within the range of 0 and 1.

A source IP dispersion, a source port number dispersion, a destination port number dispersion, a destination IP dispersion and a traffic quantity dispersion of traffic generated over a time period T′ may be represented by lines 360, and a source IP dispersion, a source port number dispersion, a destination port number dispersion, a destination IP dispersion and a traffic quantity dispersion of traffic generated over a time period T″ may be represented by lines 370. The time periods T′ and T″ may be determined using Equations (2):

T′=a*T

T″=b*T′ (2)

where a and b is integer greater than 0.

In this manner, a network administrator may determine whether an abnormal phenomenon has occurred in a wireless network based on the source IP dispersion, the source port number dispersion, the destination port number dispersion, the destination IP dispersion and the traffic quantity dispersion of traffic generated over a predetermined period of time. The abnormal phenomenon detection module 242 of the security event information display unit 240 may determine whether an abnormal phenomenon has occurred in a wireless network based on the source IP dispersion, the source port number dispersion, the destination port number dispersion, the destination IP dispersion and the traffic quantity dispersion of traffic generated in the wireless network over a predetermined period of time.

Referring to FIG. 3, RF signal information, which is obtained by collecting RF signals, may be displayed in an AP information display window 380. The RF signal information may include the SSID, extended service set identifier (ESSID) and IP information of an AP, the number of hosts to which the AP is connected, and least recent packet generation time information and most recent packet generation time information of the AP.

In this manner, it is possible to allow a network administrator to readily recognize detailed information regarding an AP by displaying both traffic information and RF signal information at the same time.

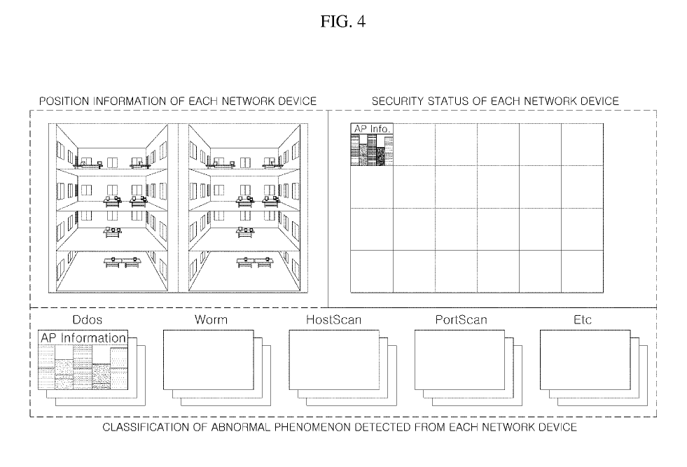

FIG. 4 illustrates a diagram of a security status screen for displaying the security status of a wireless network according to an exemplary embodiment of the present invention. Referring to FIG. 4, the security status screen may include a first region in which a 3D representation of a building is displayed in order to indicate the positions of wireless network devices and hosts, a second region in which the security status of a wireless network device to be managed is displayed, and a third region in which the classification of abnormal phenomena that can be detected from the wireless network device to be managed is displayed.

A 3D representation of a building with more than one story or a 3D representation of more than one building may be displayed in the first region. An abnormal wireless network device or host from which an abnormal phenomenon is detected may be distinctively displayed in the second region using geometric figures and/or characters.

More specifically, the security status of a wireless network device may be displayed in the second region using the method shown in FIG. 3. RF signal information and traffic information may also be displayed in the second region.

Abnormal phenomena that can be detected from a wireless network device may be classified into Ddos, Worm, HostScan, and PortScan, and the results of the classification may be displayed in the third region.

The security status screen may also include a region for displaying the positions of wired network devices and hosts, a region for displaying the security status of a wired network device to be managed, and a region for displaying the classification of abnormal phenomena that can be detected from the wired network device to be managed.

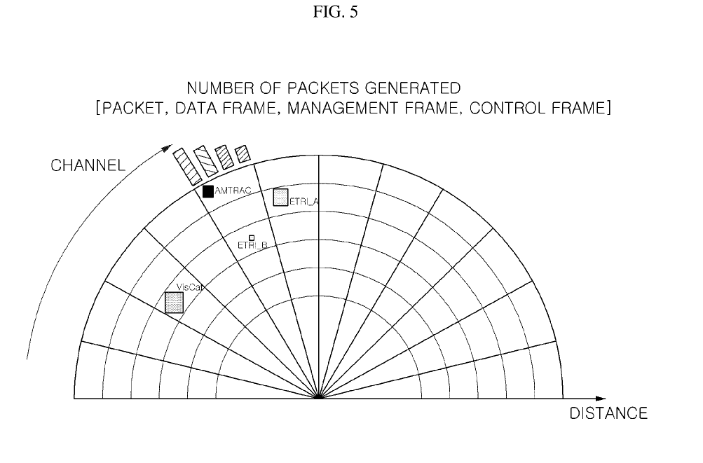

FIG. 5 illustrates a diagram of a security status screen for displaying the security status of a wireless network according to another exemplary embodiment of the present invention. Referring to FIG. 5, a plurality of APs may be mapped onto a semicircle, which is divided into N sections respectively corresponding to N channels, according to the distances of the APs from the apparatus 100 and the channels used by the APs. The distances of the APs from the apparatus may be determined based on the intensity of packets received from the APs. The number of packets generated by each of the APs, the number of hosts to which each of the APs is connected, information indicating whether data transmitted by each of the APs is encrypted, and information indicating an encryption method, if any, used by each of the APs may be displayed on the security status screen using geometric figures and/or characters. In addition, statistical information regarding packets generated in each of the N channels may be displayed along the boundary of the semicircle using geometric figures and/or characters.

The present invention can be realized as computer-readable code written on a computer-readable recording medium. The computer-readable recording medium may be any type of recording device in which data is stored in a computer-readable manner. Examples of the computer-readable recording medium include a ROM, a RAM, a CD-ROM, a magnetic tape, a floppy disc, an optical data storage, and a carrier wave (e.g., data transmission through the Internet). The computer-readable recording medium can be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for monitoring the security status of a wireless network, the apparatus comprising:
a radio frequency (RF) signal collection unit which collects at least one piece of RF signal information;
a security event information collection unit which collects security event information including at least one of traffic information and alert information;
a security event information mapping unit which maps the RF signal information and the security event information based on the correlation between the RF signal information and the security event information; and
a security event information display unit which displays the result of the mapping performed by the security event information mapping unit.

2. The apparatus of claim 1, wherein the security event information mapping unit collects the RF signal information from one or more RF signal collectors, classifies the collected RF signal information into one or more groups respectively corresponding to a number of wireless network devices, integrates RF signal information included in each of the groups, analyzes the correlation between the integrated RF signal information and the security event information and maps the integrated RF signal information and the security event information based on the results of the analysis.

3. The apparatus of claim 1, wherein the security event information mapping unit maps the traffic information and detailed access point (AP) information, which is obtained by collecting the RF signal information, for each wireless network device.

4. The apparatus of claim 1, wherein the security event information display unit calculates a dispersion of traffic generated from a wireless network over a predetermined period of time, determines whether an abnormal phenomenon has occurred in a wireless network based on the result of the calculation, classifies the abnormal phenomenon, and displays the result of the classification.

5. The apparatus of claim 1, wherein the security event information display unit displays a security status screen including a first region in which position information of one or more wireless network devices is three-dimensionally displayed, a second region in which the security status of each of the wireless network devices is displayed, and a third region in which the classification of an abnormal phenomenon, if any, detected from each of the wireless network devices is displayed.

6. The apparatus of claim 5, wherein the second region includes an AP information display window in which an service set identifier (SSID), an extended service set identifier (ESSID), and IP information of each of the wireless network devices, the number of hosts to which each of the wireless network devices is connected, and least recent packet generation time information and most recent packet generation time information of each of the wireless network devices are displayed.

7. The apparatus of claim 1, wherein the security event information display unit maps a plurality of APs onto a semicircle or circle which is divided into N sections respectively corresponding to N wireless channels according to the distances of the APs from the apparatus, and displays AP information and the RF signal information in the semicircle or circle using geometric figures and characters.

8. The apparatus of claim 7, wherein the security event information display unit displays statistical information regarding each of the N channels along the boundary of the semicircle or circle using geometric figures and characters.

9. The apparatus of claim 1, wherein the RF signal information includes at least one of an SSID and a media access control (MAC) address of an AP, information regarding a channel used by the AP, the number of packets generated by the AP, the number of packets generated for each wireless channel, cyclic redundancy check (CRC) error information, integrity check value (ICV) error information, and the internet protocol (IP) address and MAC address of a host to which the AP is connected.

10. The apparatus of claim 1, wherein the security event information includes at least one of source IP information, destination IP information, source port number, destination port number and protocol information of traffic.

11. A method of monitoring the security status of a wireless network, the method comprising:
(i) collecting at least one piece of RF signal information;
(ii) collecting security event information including at least one of traffic information and alert information;
(iii) mapping the RF signal information and the security event information based on the correlation between the RF signal information and the security event information; and
(iv) displaying the result of the mapping.

12. The method of claim 11, wherein (iii) comprises collecting the RF signal information from one or more RF signal collectors, classifying the collected RF signal information into one or more groups respectively corresponding to a number of wireless network devices, integrating RF signal information included in each of the groups, analyzing the correlation between the integrated RF signal information and the security event information and mapping the integrated RF signal information and the security event information based on the results of the analysis.

13. The method of claim 11, wherein (iii) comprises mapping the traffic information and detailed AP information, which is obtained by collecting the RF signal information, for each wireless network device.

14. The method of claim 11, wherein (iv) comprises calculating a dispersion of traffic generated from a wireless network over a predetermined period of time, determining whether an abnormal phenomenon has occurred in a wireless network based on the result of the calculation, classifying the abnormal phenomenon, and displaying the result of the classification.

15. The method of claim 11, wherein (iv) comprises displaying a security status screen including a first region in which position information of one or more wireless network devices is three-dimensionally displayed, a second region in which the security status of each of the wireless network devices is displayed, and a third region in which the classification of an abnormal phenomenon, if any, detected from each of the wireless network devices is displayed.
